(19) United States
(12) Patent Application Publication
(10) Pub. No.: US 2018/0209584 A1
(43) Pub. Date: Jul. 26, 2018

(54) Pivoting computer tablet forearm holder with interchangeable holding barace

(71) Applicant: Charles Stutesman, Sturgis, MI (US)

(72) Inventor: Charles Stutesman, Sturgis, MI (US)

(21) Appl. No.: 15/732,761

(22) Filed: Dec. 26, 2017

Related U.S. Application Data
(60) Provisional application No. 62/499,197, filed on Jan. 20, 2017.

(51) Int. Cl. F16M 13/04; F16M 11/06; F16M 11/04

(52) U.S. Cl. CPC F16M 13/04; F16M 11/06; A45F 2005/008; A45F 2200/0525; F16M 11/041

(57) ABSTRACT

Disclosed is an apparatus to securely hold a tablet computer to the forearm with functionality to rotate said tablet computer toward one's line of sight thereby allowing data entry and subsequently 180° rotation away for unimpeded arm and hand use. Apparatus is comprised of an ergonomically designed forearm sleeve designed with two 180° pivot guides to be inserted into two receiving grooves designed into the interchangeable tablet computer holder, allowing a secure fit, pivoting action and releasability. The tablet computer holder component has two corner receptors for the tablet computer distal edges and a top tension clip, with a stylus holder built in, to securely hold tablet computer while allowing easy insertion and extraction. The manufacture is comprised of two interconnected components of injection molded plastic. Design can fit a specific tablet computer and/or arm size, and/or interchangeable to fit additional tablet computer component sizes.

### CROSS REFERENCE TO RELATED APPLICATION

This application claims the benefit of U.S. Provisional Application No. 62-499197 filed on Jan. 20, 2017, entitled “Pivoting Computer Tablet Forearm Holder with Interchangeable Holding Brace.”

### BACKGROUND OF THE INVENTION

### Field of the Invention

The present invention relates to a device for holding and pivoting a portable computing device. More specifically, the present invention incorporates a more functional pivoting design allowing easy access to a tablet computer utilizing the present invention. A tablet computer can be positioned on the forearm for easy and secure data entry while the pivoting design thereby allows more functional use of arms and hands when not in use. The rotational component allows use of both hands while keeping the tablet computer easily accessible when data entry is again necessitated.

Computer Tablet sales have grown from 10 million units in 2010 to over 174 million in 2016 (Statista 2017). With this increase comes the need to develop devices allowing more efficient and ergonomical use of such products. This use comes in all types of forms; desk, traveling, while moving around, use in different physical environments, etc. Many professions have a constant need to keep a computer tablet in close proximity with the use being intermittent.

Problem areas that currently relate to said intermittent use of a computer tablet use include having to hold in one hand during use, need to keep a computer tablet close while easily accessible with minimal loss of use of hands, stability when in use, lost time in putting down or storing the computer tablet, subsequent lost time in retrieving the computer tablet to make data entry, hand and arm fatigue, constant need to hold, need to store and retrieve the computer tablet, and cost of dropped and damaged computer tablets.

The original idea for this materialized during notetaking in seed corn and soybean parent seed fields using a computer tablet. It was necessary to hold on to the tablet while making notes, walking across several acres making individual plant examinations on the corn and soybeans. Data entry was tedious and tiring, with fatigue due to continued grasping. Use of both hands was necessary but impeded with the need to carry, store, or set aside the computer tablet. With the need for multiple data points to examine and record on each plant, data entry was inefficient with the current system.

Additional uses of this type of said device became obvious. Warehouse workers hold on to laptop computers or need to set them down to do physical inventory. Patient observations by health professionals in hospital or office settings will require more ergonomically designed devices as electronic analysis and record keeping progress. Retail settings where workers try to hold computer tablets while entering customer orders offer key market potential. Easily accessible computer usage in university and college settings have become prolific yet underserved in respect to ergonomic accessories. Any setting where time sensitive, ergomically challenging data capture is necessary for better efficiency are a sample of the target markets for the present device.

### Description of the Prior Art

The following terms were searched in the USPTO Patent Full-Text and Image database and returned no resulting patents: Rotating Laptop Holder, Armband Computer, Computer Arm Holder, Computer Tablet Arm Holder, Arm Assisted Laptop Holder, Laptop Arm Holder, Laptop Holder for Arm, Laptop Clasp, Laptop Arm Support, Portable Arm Holder, Portable Computer Holder, Portable Laptop Holder, Tablet Arm Support, Wrist Computer Holder, Tablet Arm Clasp, Computer Arm Clasp, and Laptop Arm Clasp.

Mobile computer holder yielded two results. U.S. Pat. No. 9,775,426, Amacher, Mobile Computer-Holding Device is a pocket holder for holding when not in use. U.S. Pat. No. 7,764,488, Calvarese, includes no rotational component, memory on band, wrist, may include coupling to the dock, computing device coupled to the dock, automatically adopt mode of another computing device. Main component appears to be focused on the coupling and memory retrieval.

Computer Holder yielded the following patents that has some relevance to the present device.

U.S. Pat. No. 9,675,166, Mick, Mick, discloses and ergonomically designed hand held device. The present device offers a different functional design with rotational benefits, storage benefits, continued hand use as a result of the present device not requiring the use of a hand to hold a tablet computing device.

U.S. Pat. No. 9,486,910, Stevens, Augood, discloses a hand held design with the tablet held in one hand with use of one or more fingers inserted into an aperture. The present device offers the aforementioned advantages relating to rotational benefits, storage benefits, continued hand use as a result of the present device not requiring the use of a hand to hold the tablet computing device.

U.S. Pat. No. 8,757,374, Kaiser is also designed to be place on top of a table, desk, etc. and not specifically designed for use in dynamic environments. Similar comparison can be made in reference to U.S. Pat. No. D673960, Lindfield, Lindfield, whereas referenced device attaches to a stationary stand and the rotational aspect is confined to the receptacle design in the stand attachment. Similar comparison can be made in reference to U.S. Pat. No. 8,325,334, Kobal, whereas referenced device is and upright, self-standing or anchorable device under the legs of a person in a seated position and is confined to the seated position of the individual.

U.S. Pat. No. 9,145,158, Cruz, discloses tablet computer holder secures tablet to, stroller, chair, table, or the like.

U.S. Pat. No. 8,941,989, Pollex, discloses another hand held device requiring use of the hand to hold a handle attached to the tablet computer, and while it may be used to enter data, it provides no opportunity to use both hands while the computer is in use or ability to use both hands while tablet computer is stored on arm for easy access and use as the present device.

U.S. Pat. No. 8,702,055, Alemozafar, Royker, details a hand held device held primarily via a slot and finger grooves for permitting to hold the portable electronic device. Present device allows many more environmental, rotational, use of hand advantages in settings requiring intermittent use and use of both hands.

U.S. Pat. No. 8,885,338, Simpson, discloses a hand held device but appears to be more aligned to a carrying device requiring the continuous use of the hand to carry said device and tablet computer.

U.S. Pat. No. D706274, Shubin, Sr., discloses an ornamental design which appears to be the actual tablet computer and electronic components shell, possibly for use in conjunction with specific construction of the tablet computer itself as compared to a variety of tablet computers as is with the present device. In addition, it appears the aforementioned ornamental design has a more restricted rotational aspect and restricted ergonomic design flexibility.

U.S. Pat. No. D704195, Marquette, describes a design patent which appears to be more functional in a stationary use attached to a desk or wall setting, thus lacking the rotational, dynamic use in various environments as offered by the present device.

A portable computer holder USPTO search under wrist holder yielded the Wrist-Mountable Device, U.S. Pat. No. 5,904,280 with a functional tool related device for holding a tape measure, light, and magnet. The present device is more suitable to tablet computing and has more rotational function than the aforementioned device.

Many related to phone size holders requiring hand use, i.e. U.S. Pat. No. 9,723,116, Georges; U.S. Pat. No. 8,939,333, Alvarez; U.S. Pat. No. 8,328,055, Synder.

Portable Computer Holder With Adjustable Hand Grip, Pub. No. U.S. 2013/0140837 A1, Carroll, yielded a portable device incorporating a holder base and an extending dome shaped grip extending from the rear. The holder engages four distal edges to hold the computer by gripping using one or more fingers. The grip can be collapsable. The present device incorporates a more functional design from a viewing standpoint, the use of both hands while in use, and a more ergonomically designed arm holder for less hand stress.

Wrist Clamp yielded U.S. Pat. No. 5,154,506, Leard, flashlight holder with an adjustable elastic strap with a sleeve. The present device will also utilize a possible strap similar to the aforementioned strap for securing the arm holder to the arm. The strap for the present device will be different in the elastic one piece, overlapping design with velcrow attachment.

### SUMMARY OF THE INVENTION

In view of the foregoing disadvantages of known devices, or lack of applicable designs in addressing the issues addressed, the present device is designed to be more functional to minimize fatigue and facilitate data entry whereby fatigue is minimized and more elongated and efficient data entry, data transmission, or communication transpires.

The forearm holder allows a computer tablet to be pivoted into place to enter data and then be pivoted away to allow hand utilization and movement. The design of the computer tablet holder component and also the holding brace sleeve are such that the size of each can be modified to fit almost any computer tablet and any arm size. A strap, not shown, to be inserted in openings on the forearm holder, can also be attached to provide extra stability if needed. A stylus holder is also designed into the computer tablet holder for convenience. The manufacture will be comprised of three parts, the computer tablet holder, the forearm sleeve, and an optional strap (not shown), whereby the computer tablet holder and the forearm sleeve will be injection molded, subsequently assembled in one procedure.

### BRIEF DESCRIPTIONS OF THE DRAWINGS

FIG. 1 shows the downward from top right forward view of the said device comprised of two components, the computer tablet holder and underlying pivot mechanism.

1A is a top right downward, front surface view of the Pivoting Computer Tablet Forearm Holder with Interchangeable Holding Brace and notes the two bottom base corner holders of the tablet.

1B show the top clip which utilizes adjustable, tensile resistance to move up to place the tablet in the holder and use opposite tensile strength from the top down to hold the table firmly in place.

FIG. 2 shows a lower left, side view of the present device.

2A notes the forearm holder with a rounded design to fit comfortably on the arm and can be designed as individual sizes or as an adjustable shape to accommodate various arm sizes.

2B details two small stadium shaped, narrow slots to enclose an optional strap, not shown, encircling the underlying pivot mechanism adding additional tensile strength to hold the present device securely on the arm.

FIG. 3 is a downward top right frontal view depicting the computer tablet holder component of the device.

3A notes the computer tablet back plate including the stylus holder. The top corners are both angled and include cut out areas to reduce weight without compromising strength to hold computer tablet in place and secure.

3B represents an area dedicated to putting logos should those be desired.

FIG. 4 is a reverse view and denotes the guides that will slide into the receiving mechanism on the interchange forearm brace component.

4A represents the aforementioned receiving guides for the forearm holder which the forearm holder will slide into allowing the pivot action.

FIG. 5 is a side view of the forearm holder.

5A represents the edge being designed to be comfortably slide in place on the interchangeable forearm brace and will be slightly rounded on all sides to accommodate various arm sizes and allowing a comfortable fit.

5B represents the three locking pivot positions for the computer tablet holder to be secured, one position for the computer tablet to face away from one's body when not in use, one intermediate position, and the third position facing the person.

FIG. 6 shows the pivot channels on the forearm holder which will receive the computer tablet holder.

6A represents a view of the pivot channels.

6B represents one end where there will be an adjustable entry slide which will allow the pieces to be combined or released to adjust the arm band or replacement if needed by a user with a different size arm.

### DETAILED DESCRIPTION OF THE INVENTION

Reference is made herein to the attached drawings.

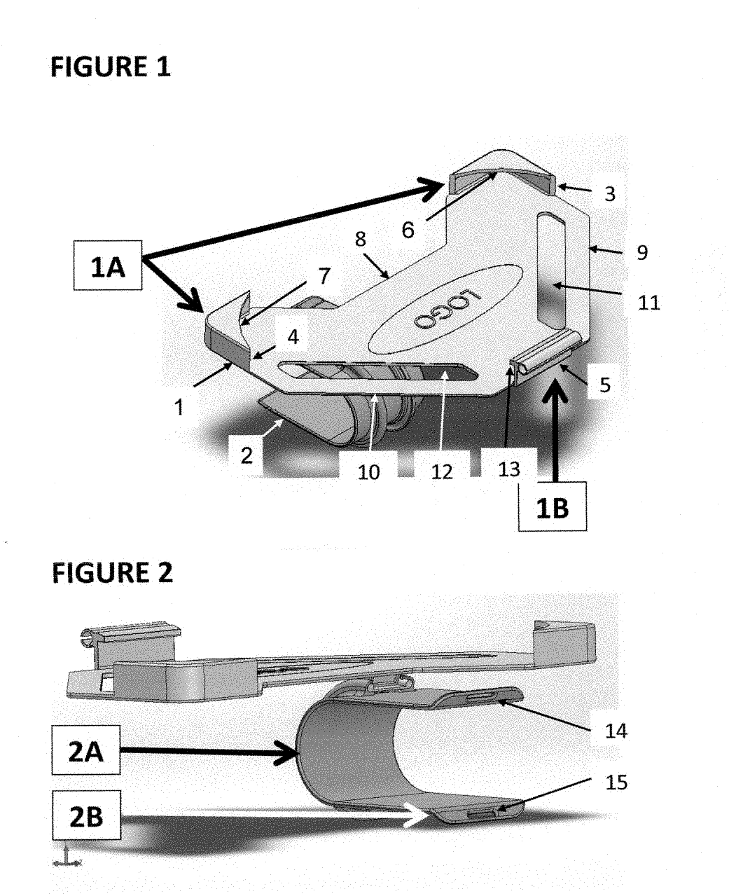

FIG. 1 shows the basic design of the computer tablet forearm holder, 1, and the interchangeable holding brace, 2, which will slide onto the user's forearm.

1A notes the two bottom base corner holders of the computer tablet. The two bottom corner holding edges, 3, 4, and the top tensile computer tablet holding clip, 5, can be designed at different specific height requirements accommodating different tablet computer widths. The corners, 6, 7, are designed so as not to impede the lower right or lower left computer tablet screen viewing. The bottom area edge, 8, is indented to reduce weight without compromising strength and will allow easier access for interchangeable holding brace components, 2. The top corners are also trimmed, 9, 10, and cut out, 11, 12, reducing weight without compromising strength to securely hold the computer tablet.

1B shows the clip mechanism, 5, to hold the computer tablet securely through tensile strength while allowing uncomplicated, one-handed insertion and extraction. The width and height of the clip can vary to match the specific computer tablet holder if necessary. The width of the lip, 13, in contact with the computer tablet can also vary depending on specific computer tablet model requirement.

FIG. 2 shows an upward from bottom left view.

2A denotes the interchangeable holding brace for a forearm and will fit various forearm sizes. The aforementioned holding brace size will also vary. The brace will utilize tensile strength in addition to an optional strap, not shown. The forearm holder for the computer tablet 2.2B shows two slots, 14, 15, for the optional strap noted earlier to provide additional pressure to hold the machine firmly in place on one's arm. All edges will be rounded for comfort.

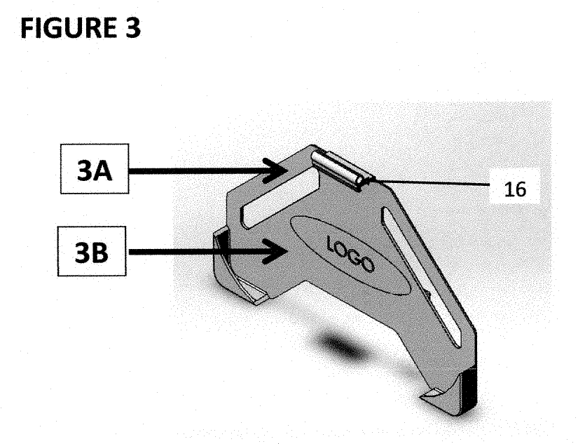

FIG. 3 shows the computer tablet holder alone.

FIG. 3.3A represents said stylus holder built into the clip which can also be used for a pen, pencil, or marker. Said tensile locking mechanism is manually raised by thumb or finger to insert computer tablet and subsequently raised in similar motion to extract the computer tablet. Included is a lip exerting sufficient downward tensile strength to keep the computer tablet securely inserted in the two lower corner holders, 1A. Included in said tensile locking mechanism, 1B, is a receptacle, 16, for holding a stylus. For computer tablets with built-in stylus holders, removal of areas 9, 10, allow easier access to the included stylus.

3B represents an area dedicated to putting logos should those be desired. Said logos can be imprinted into the base material or attached by adhesive.

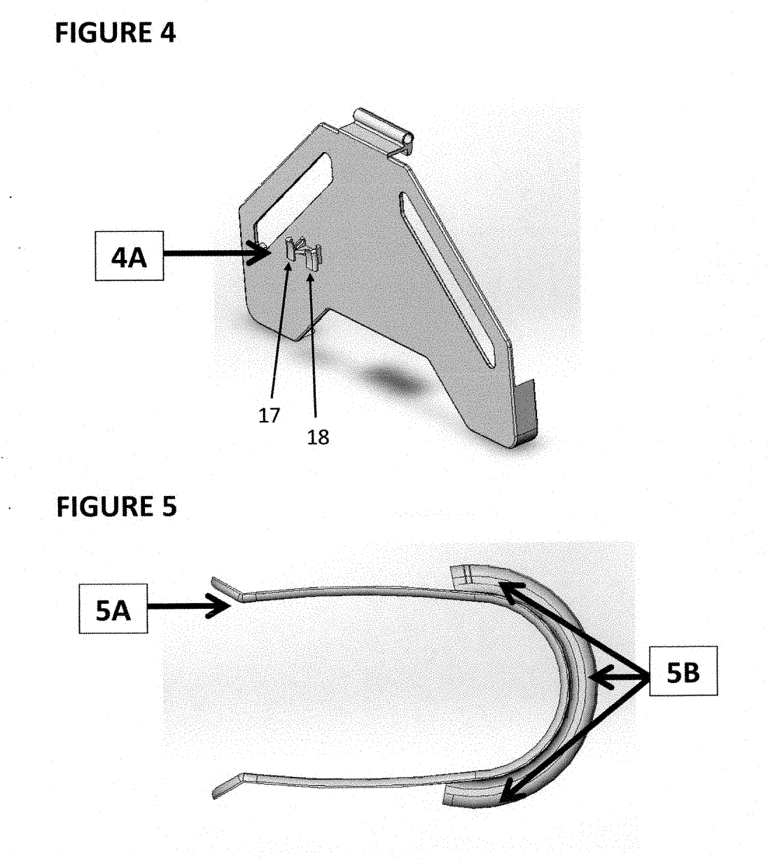

FIG. 4 is a reverse view of said computer tablet holder. 4A represents the base holder guides which are inserted into the receiving guides on the interchangeable holding brace. The base holder is injection molded as a continuous appendage to the computer tablet holder and is comprised of two rounded tubular base holder guides 17, 18, allowing insertion into, removal, and pivoting action on the aforementioned brace, FIGS. 2, 5, and 6.

FIG. 5 is a side view of the forearm holder. Said forearm holder will be ergonomically designed to comfortably slide onto the arm and fit the contour of the lower forearm and will be slightly rounded on all sides. The size or sizes will accommodate various arm sizes.

Entering edges, 5A, will be angled to allow ease of sliding onto and off of forearm. The design will accommodate both arms, or be contoured to specifically fit the left or right arm.

5B notes three locations where there will be indented locking slots to secure the computer tablet in differing location; one when not in use, and two locations that will allow computer tablet access, viewing, communication, and data entry. The number of positions are herein noted as three but can be increased or decreased depending on the necessity and particular use required. In addition, the design will be flexible to adjust to either right or left arm use.

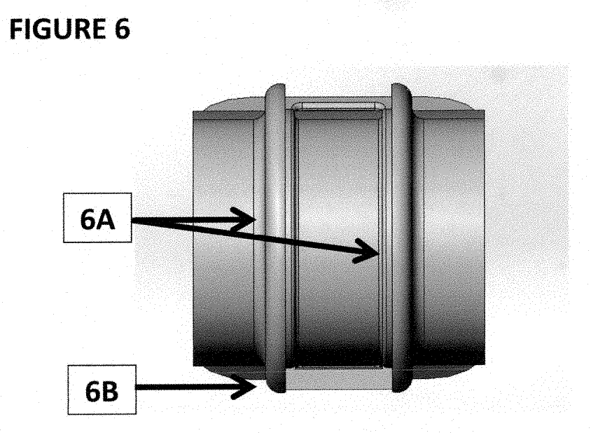

FIG. 6 shows the interchangeable holding brace for the forearm including the receiving pivot channels for the two base holder guides, FIG. 4, 17,18, on the back of the computer tablet holder.

6A represents an overview of the receiving pivot channels on the interchangeable holding brace where the base holder guides 4A would be inserted and pivot approximately 180 degrees. The receiving pivot channels will exert tensile strength and friction upon the base holder guides, 17, 18, and the three resting positions, 5B.

6B represents the end where the base holder guides, 17, 18, will slide into the receiving pivot channels where a tensile clip will subsequently hold the base holder guides in the receiving pivot channels until released by the user and separated. The adjustable entry slide and two tensile locking points will allow the pieces to be interchanged if a replacement of either the computer tablet holder or interchangeable brace holder is warranted.

### Mode of Carrying Out Manufacture

The pieces will be injection molded from a flexible elastomer material so as to allow the manipulation during assembly and subsequent required manipulation to insert, hold secure, and detach computer tablet. The assembly will require two steps. First, the pivot mechanism is attached to the computer tablet holder. Second, the strap being attached to the pivot mechanism. To unassemble, the holding clips, 6B, will be manipulated to allow release of the two components. Different colors may be utilized for different industry needs or desires.

### REFERENCES CITED

U.S. Pat. No. D673960, Lindfield, Lindfield
U.S. Pat. No. D704195, Marquette
U.S. Pat. No. D706274, Shubin, Sr.
U.S. Pat. No. 5,154,506, Leard
U.S. Pat. No. 5,904,280, Chan
U.S. Pat. No. 7,764,488, Calvarese
U.S. Pat. No. 8,325,334, Kobal
U.S. Pat. No. 8,328,055, Snyder
U.S. Pat. No. 8,702,055, Alemozafar, Royker
U.S. Pat. No. 8,757,374, Kaiser
U.S. Pat. No. 8,885,338, Simpson
U.S. Pat. No. 8,939,333, Alvarez
U.S. Pat. No. 8,941,989, Pollex
U.S. Pat. No. 9,145,158, Cruz
U.S. Pat. No. 9,486,910, Stevens, Augood
U.S. Pat. No. 9,675,166, Mick, Mick
U.S. Pat. No. 9,723,116, Georges
U.S. Pat. No. 9,775,426, Amacher
Pub. No. U.S. 2013/0140837 A1, Carroll.

I claim:

1. A pivoting computer tablet forearm holder with interchangeable holding brace comprising:
a computer tablet holder with guide pivotably carried by a forearm holder;
said computer tablet holder slidably fitted in a guide groove on the said forearm holder.)

2. The device of claim 1, wherein said computer tablet holder will rotate roughly 180 degrees on guide on said computer tablet holder in a contiguous manner, with guide further including three position receptacle indentations on the said computer tablet holder guide and corresponding dimples on said forearm holder securely locking said device in viewing and non-viewing predetermined positions.)

3. The device of claim 1, wherein said computer tablet holder further comprising a top releasably latching mechanism to hold computer tablet securely onto computer tablet holder, further including a computer tablet stylus holder comprised of a receptacle corresponding to the size of the stylus;)

4. The device of claim 1, wherein said forearm holder further comprises a guide groove for an optional adjustable strap to go around the forearm to provide additional support of said forearm holder and said computer tablet holder and inserted computer tablet;)

5. The device of claim 1, formed from injection molded plastic for a lightweight, durable, flexible frame available in multiple colors
